(19) United States
(12) Patent Application Publication
(10) Pub. No.: US 2011/0109226 A1
(43) Pub. Date: May 12, 2011

(54) MICROPLASMA DEVICE WITH CAVITY FOR VACUUM ULTRAVIOLET IRRADIATION OF GASES AND METHODS OF MAKING AND USING THE SAME

(75) Inventors: James Edward COOLEY, San Francisco, CA (US); Gregory S. LEE, Mountain View, CA (US); Arthur SCHLEIFER, Portola Valley, CA (US); Robert C. TABER, Palo Alto, CA (US); Randall URDAHL, Mountain View, CA (US); Martin L. GUTH, Colorado Springs, CO (US); Lewis R. DOVE, Monument, CO (US)

(73) Assignee: AGILENT TECHNOLOGIES, INC., Loveland, CO (US)

(21) Appl. No.: 12/613,643

(22) Filed: Nov. 6, 2009

(51) Int. Cl. H05B 31/26

(52) U.S. Cl. 315/111.21

(57) ABSTRACT

An illumination device provides light to a flowing gaseous sample. The device includes a structure including a cavity configured to have a microplasma disposed therein. The cavity substantially encircles a cross-section of a channel that is configured to pass the flowing gaseous sample therethrough. The cavity is defined in part by an interior wall of the structure separating the cavity from the channel. The interior wall includes at least one orifice passing therethrough configured to provide to the flowing gaseous sample light generated by the microplasma. At least one electrode is configured to supply energy to the microplasma within the cavity.

### BACKGROUND

Electromagnetic energy may be employed to facilitate examination of the composition of an unknown gas via photochemistry applications such as soft ionization and photo-fragmentation. The vacuum ultraviolet (VUV) region of the electromagnetic spectrum is particularly useful in these applications because the energies of VUV photons (generally 6-124 eV) correspond to electronic excitation and ionization energies of most chemical species. Vacuum ultraviolet (VUV) light is generally defined as light having wavelengths in the range of 10-200 nanometers.

Most existing systems involve generating VUV light remotely from the area to be exposed, for example using a resonance lamp, frequency-multiplied laser, or synchrotron, and attempting to deliver this light to the area of interest, typically by passing the VUV light through a window. However, window materials and refractive optics in this wavelength range are scarce or non-existent, so it is often impractical to direct or concentrate VUV light. The windows that are employed typically absorb a large fraction of light in this wavelength spectrum, and reflective optics can become contaminated in a less-than perfectly clean environment. In addition, lasers and synchrotrons can be prohibitively expensive and can require large amounts of power and space.

What is needed, therefore, are better systems and methods of generating VUV light and delivering it to an area of interest.

### SUMMARY

In an example embodiment, a device comprises: a structure defining a cavity, the cavity substantially encircling a cross-section of a channel passing through the structure, the cavity being defined in part by an interior wall of the structure separating the cavity from the channel, the interior wall including at least one orifice passing therethrough, the structure further includes an inlet port connected to the cavity and configured to receive a source gas; a microplasma disposed within the cavity and generating light that at least in part passes through the at least one orifice in the interior wall; at least one ignition device for striking the source gas received via the inlet port to generate the microplasma; and at least one electrode for supplying energy to the microplasma within the cavity.

In another example embodiment, a method is provided for exposing a gaseous sample to an excitation light. The method comprises: providing a structure defining a cavity, the cavity substantially encircling a cross-section of a channel passing through the structure, the cavity being defined in part by an interior wall of the structure separating the cavity from the channel, the interior wall including at least one orifice, the structure further defining an inlet port connected to the cavity; providing a source gas to the inlet port; generating a microplasma from the source gas; providing the microplasma to an interior of the cavity, the microplasma generating light that at least in part passes through the at least one orifice in the interior wall; supplying energy for sustaining the microplasma within the cavity; and passing the gaseous sample through the channel so as to expose the gaseous sample to the light generated by the microplasma and to excite or ionize at least one chemical species in the gaseous sample.

In yet another example embodiment, an illumination device is provided for supplying light to a flowing gaseous sample. The device comprises: a structure including a cavity configured to have a microplasma disposed therein, the cavity substantially encircling a cross-section of a channel that is configured to pass the flowing gaseous sample therethrough, the cavity being defined in part by an interior wall of the structure separating the cavity from the channel, the interior wall including at least one orifice configured to provide to the flowing gaseous sample light generated by the microplasma; and at least one electrode configured to supply energy to the microplasma within the cavity.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates a cross-sectional view of one example embodiment of a microplasma vacuum ultraviolet irradiation device.

FIG. 2 illustrates an exploded view of some components of one example embodiment of a microplasma vacuum ultraviolet irradiation device.

FIG. 3 shows a top view of one example embodiment of a microplasma vacuum ultraviolet irradiation device.

FIG. 4 illustrates an exploded view of the example embodiment of a microplasma vacuum ultraviolet irradiation device shown in FIG. 3.

FIG. 5 illustrates one example embodiment of a cavity structure for a microplasma vacuum ultraviolet irradiation device.

FIG. 6 is a detailed illustration of one example embodiment of a cavity structure for a microplasma vacuum ultraviolet irradiation device.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

As used herein, the word “light” includes visible light, infrared light, and ultraviolet light, particularly including vacuum ultraviolet light. Also, as used herein, “approximately” means within 10%, and “substantially” means at least 75%.

An effective strategy for irradiating gaseous samples for photochemistry applications is to produce a high density light in a geometry that is convenient for coupling to the gas flow. Described below are embodiments of an illumination device that allows for efficient geometric coupling of photons emitted by light (e.g., vacuum ultraviolet (VUV) light) to a flowing gaseous sample. One embodiment involves passing the sample gas through the center hole of a toroidal microplasma discharge. In one embodiment, the toroidal microplasma occupies a volume on the order of 1 cubic millimeter. In one embodiment, the microplasma is provided in a toroidal cavity constructed with one or more orifices along an inner surface or wall thereof that allow for windowless emission of photons (e.g., VUV photons) directed radially inward to the flowing gaseous sample.

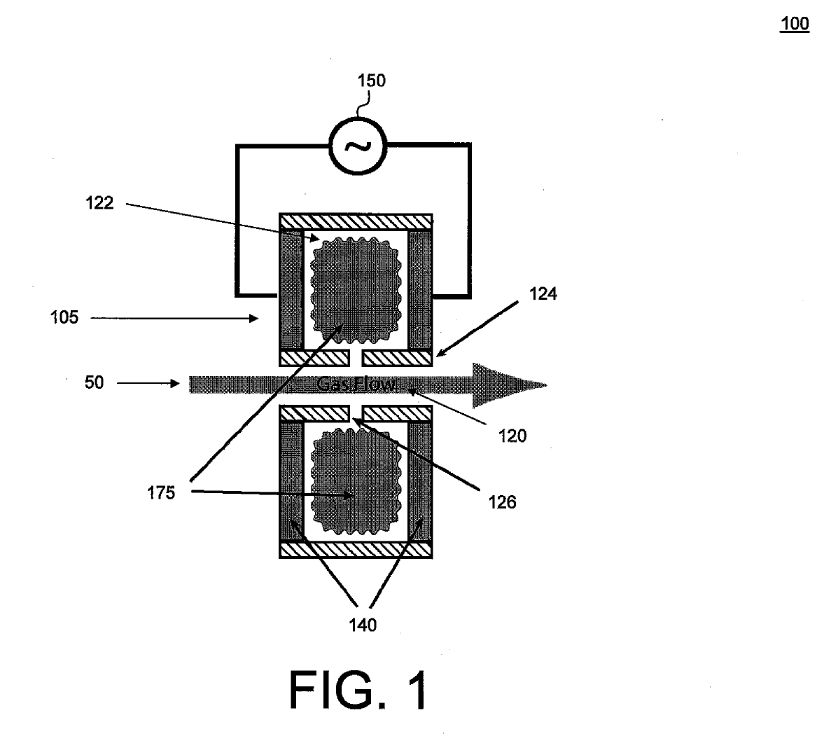

FIG. 1 illustrates a cross-sectional view of one example embodiment of a microplasma vacuum ultraviolet irradiation device 100.

Device 100 includes a structure 105 defining a channel 120, and at least one energy source 150.

Channel 120 is configured to pass a flowing gaseous sample 50 therethrough.

Structure 105 includes a cavity 122 configured to have a microplasma 175 disposed therein. Cavity 122 substantially encircles or surrounds a cross-section of channel 120 and is defined in part by an interior wall 124 of the structure separating cavity 122 from channel 120. Interior wall 124 includes one or more orifices or slits 126 configured to provide to flowing gaseous sample 50 photons from light generated by microplasma 175. In one embodiment, inner wall 124 may be cylindrical or substantially cylindrical with a circular cross-section. However, inner wall 124 may have a variety of other shapes and cross-sections, including rectangular, triangular, star-shaped, or any other convenient shape that can efficiently couple photons from microplasma 175 to flowing gaseous sample 50.

Structure 105 further includes an inlet port (not shown in FIG. 1) connected to cavity 122 and configured to receive a source gas for generating microplasma 175. In some embodiments, the source gas includes a noble gas, for example krypton, neon, argon or helium. In some embodiments, the source gas includes hydrogen. The source gas may be selected as a gas mixture or composition corresponding to the desired wavelength of light output by device 100 to flowing gaseous sample 50, for example 10% Kr in He to produce VUV light and emit photons at 10.64 and 10.03 eV. Structure 105 also includes two annular electrodes 140 connected to the energy source 150. Energy source 150 may be configured to provide energy to the source gas in the form of a DC voltage, a pulsed voltage, or an oscillating signal with some appropriate frequency such as RF or microwave to generate and maintain a plasma.

In the embodiment of FIG. 1, cavity 122 is toroidal. In the embodiment of FIG. 1, the toroidal shape of cavity 122 is generated by revolving a square around an axis external to the square. However, in other embodiments, cavity 122 may be a torus (i.e., a toroid generated by revolving a circle about an axis external to the circle) or have other toroidal shapes, such as revolving an oval, a rectangle, a triangle, or other shape around an axis external to the object.

In operation, a source gas is supplied to an inlet port (not shown in FIG. 1) of structure 105 to generate microplasma 175. An electrostatic voltage, either DC, pulsed, or oscillating with some appropriate frequency such as RF or microwave, is delivered across annular electrodes 140. The resulting electric field sustains a discharge in microplasma 175 that is confined inside toroidal cavity 122 defined by the walls of structure 105, including internal wall 124 and electrodes 140. Orifice(s) or slit(s) 126 along inner wall 124 allow for windowless light (e.g., VUV) emission directed radially inward while restricting the flow of the source gas from microplasma 175 such that a pressure differential can be maintained. In this way, sample gas 50 flowing through the center hole of toroidal cavity 122 filled with microplasma 175 is at least substantially completely enveloped in VUV light, but does not directly interact with the high-field region in microplasma 175.

Channel 120 has an inlet side on the left in FIG. 1, and an outlet side on the right in FIG. 1, where the pressure at the outlet side is lower than at the inlet side. In some applications, a mass spectrometer detector is located at the outlet side of channel 120 for detecting species present in flowing gaseous sample 50 that have been ionized by photons from microplasma 175.

In some embodiments, a microplasma vacuum ultraviolet irradiation device is fabricated from a stack of ceramic plates to form a cavity which, when filled with appropriate source gas and electrically energized, can sustain a small toroidal plasma discharge. In such embodiments, one or more orifices along an inner surface of the toroidal cavity direct optical output radially inward, providing a good coupling between emitted photons and an axially flowing gaseous sample.

Beneficially, some embodiments incorporate the use of a separate plasma ignition circuit—a microwave resonant structure that steps up the voltage on an applied microwave signal and converts non-conducting plasma gas into an ionized discharge. In this way, the circuits for maintenance of steady-state plasma and for plasma ignition may be decoupled, allowing for more design flexibility and power efficiency.

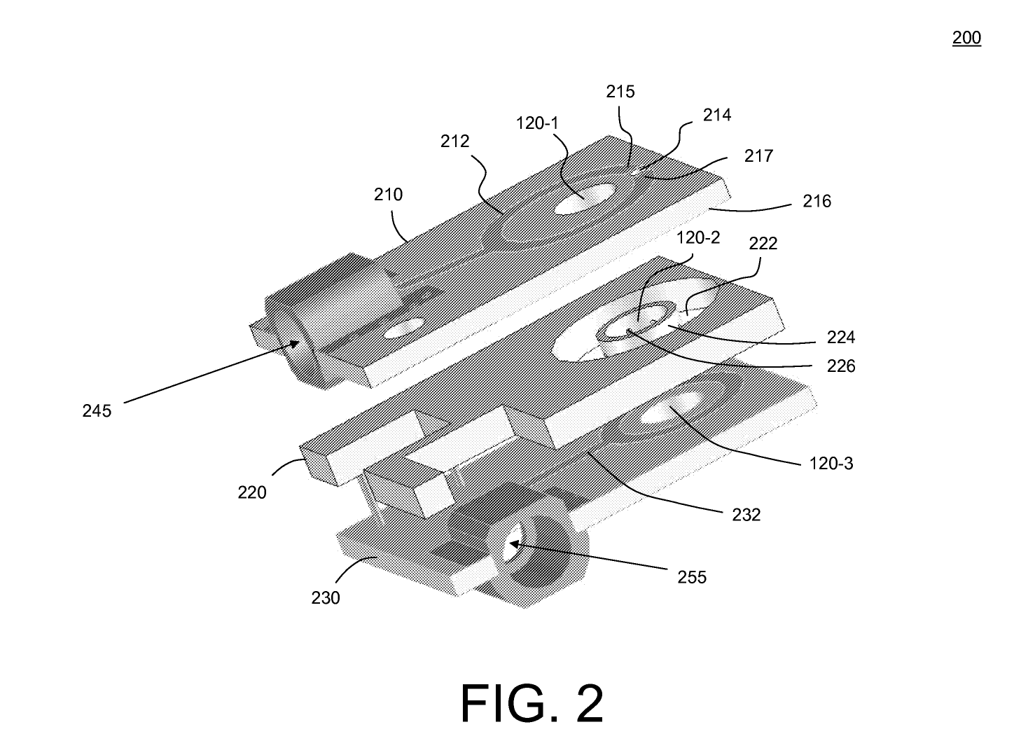

FIG. 2 illustrates an exploded view of some components of one example embodiment of a microplasma vacuum ultraviolet irradiation device 200.

Device 200 includes a first plate 210, a second plate 220 and a third plate 230, bonded together to form a desired structure. In some embodiments, first, second and third plates 210, 220 and 230 are ceramic plates. Device 200 could be manufactured using standard thick-film processes. These could include implanting or depositing metallic layers (on the order of 1-10 microns thick) on ceramic substrates, coating these layers with insulating material such as glass, and bonding the ceramic plates together to make the desired three-dimensional structure.

First plate 210 has a first aperture 210-1 passing therethrough, a second aperture, or inlet port, 214 passing therethrough, a “split-ring resonator” device 212 including first and second split-ring end portions 215 and 217, a ground plane 216, and a first power input port 245. Second plate 220 includes an inner aperture 120-2 passing therethrough, an outer aperture 222 passing therethrough and substantially surrounding inner aperture 120-2, and an insert 224 separating inner aperture 120-1 from outer aperture 222. Beneficially, inner aperture 120-2 and outer aperture 222 of the second substrate are substantially coaxial with each other. Insert 224 has a plurality of orifices 226 passing therethrough. Third plate 230 has aperture 120-3 passing therethrough, an electrode 232 disposed on a first side thereof, and a second power input port 255.

When plates 210, 220 and 230 are bonded together, apertures 120-1, 120-2 and 120-3 are aligned to form a channel 120 through which flowing gaseous sample 50 may be passed and exposed, via orifices 226, to photons generated by a microplasma disposed in a cavity formed by outer aperture 222, the bottom of first plate 210, and the top of third plate 230. Insert 224, bonded to one or both of the outer plates 210 and 230, separates toroidal plasma cavity 222 from cylindrical sample channel 120. Orifices 226 of insert 224 allow light and some plasma gas to pass from plasma chamber 222 into sample channel 120. The bottom of first plate 210 is uniformly coated with metal to form a ground plane 216 which is held at ground potential. The top of third plate 230 contains electrode trace 232 configured to be powered with a microwave or radiofrequency (RF) signal applied at second power input port 255. The ground plane and powered electrode 232 form a time-varying electric field in the plasma chamber, sustaining the toroidal microplasma discharge. The top of first plate 210 contains the trace of split-ring resonator device 212, configured to step up the voltage from a second AC electrical signal applied at first power input port 245 to produce a large electric field in the gap between split-ring end portions 215 and 217 where ring structure 212 is broken. The applied electric field is sufficiently high that a source gas applied to input port 214 in first plate 210 is broken down and plasma is ignited. This plasma flows through aperture 214 in the split-ring resonator gap and into main toroidal plasma chamber 222. In this way, split-ring resonator 212 acts as a “pilot light”, initially forming and maintaining a supply of ions and free electrons to keep the main discharge lit. Beneficially, the source gas is supplied to input port 214 at a relatively low pressure, e.g., 1-5 torrs.

In device 200 insert 224 is cylindrical or substantially cylindrical with a circular cross-section. However, insert 224 may have a variety of other shapes and cross-sections, including rectangular, triangular, star-shaped, or any other convenient shape that can efficiently couple photons from microplasma 175 to flowing gaseous sample 50.

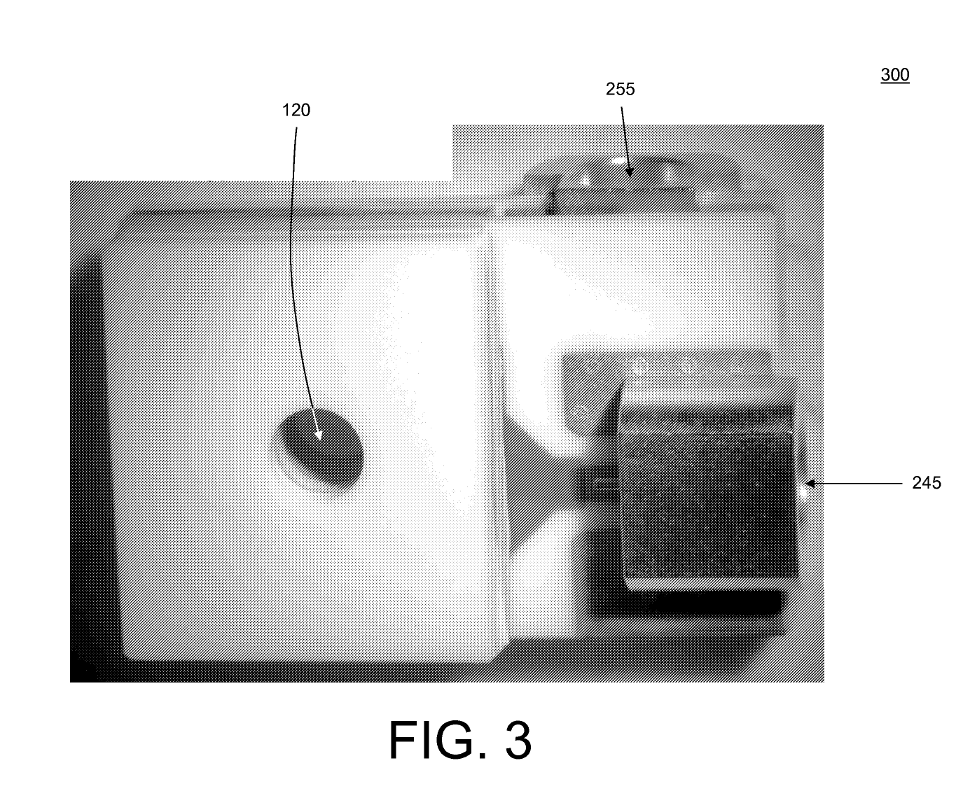

FIG. 3 shows a top view of one example embodiment of a microplasma vacuum ultraviolet irradiation device 300.

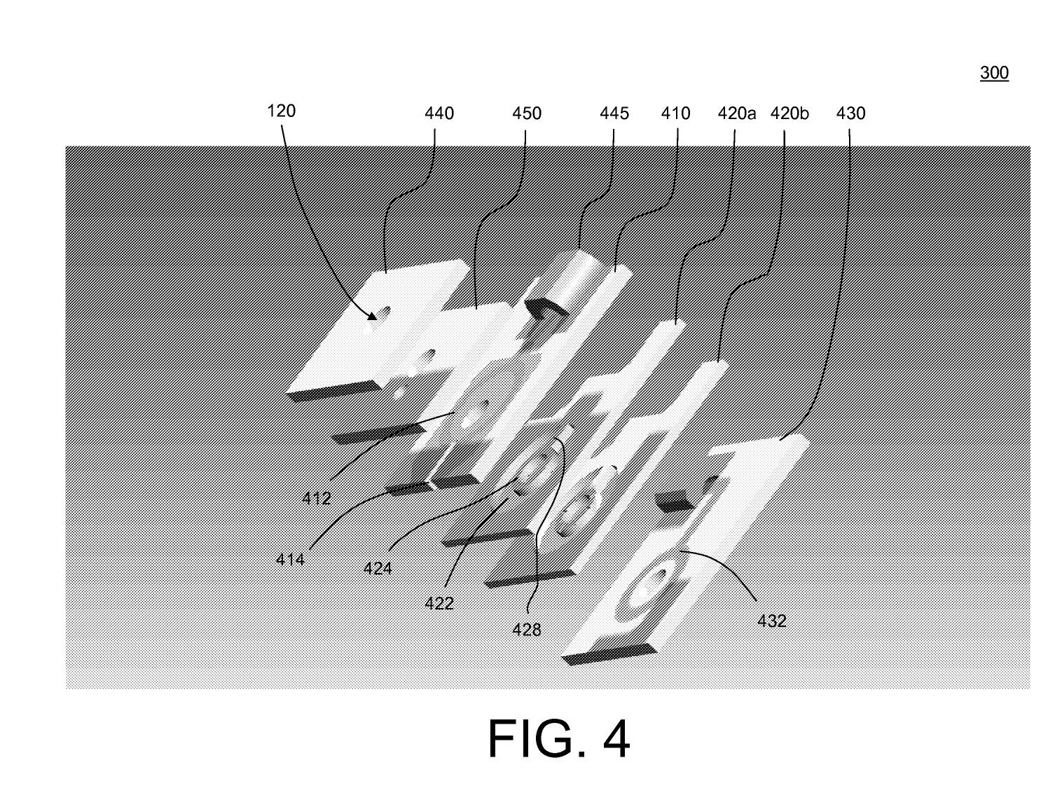

FIG. 4 illustrates an exploded view of the example embodiment of a microplasma vacuum ultraviolet irradiation device 300 shown in FIG. 3.

Device 300 includes a first plate 410, a second plate 420a, a third plate 430, a fourth plate 420b, a fifth plate 440 and a sixth plate 450. In some embodiments, first through sixth plates 410, 420a, 420b, 430, 440 and 450 are ceramic plates. Device 300 could be manufactured using standard thick-film processes. These could include implanting or depositing metallic layers (on the order of 1-10 microns thick) on ceramic substrates, coating these layers with insulating material such as glass, and bonding the ceramic plates together to make the desired three-dimensional structure. In some embodiments, one of the second and fourth plates 420a and 420b could be omitted.

First plate 410 includes aperture 414 passing therethrough, a “split-ring resonator” (e.g., a microwave resonator) device on a first side thereof, a ground plane on an opposite side from the split-ring resonator, and a first power input port 240. Second plate 420 includes outer aperture 422 passing therethrough, and an inner wall portion 424 separating outer aperture 422 from an inner aperture which forms part of channel 120. Inner wall portion 424 has a plurality of slits passing therethrough on a side that is adjacent to fourth plate 420b. Inner wall 424 is connected to the remaining portion of second plate 420 through one or more radially-extending connecting arms 428. Third plate 430 has an electrode 432 disposed on a first side thereof. Fourth plate 420b in configured similarly to second plate 420a, except that the slits passing through the inner wall portion thereof are on the opposite side, facing second plate 420a, so that together the slits in the inner wall portions of second and fourth plates 420a and 420b comprise orifices passing though the inner wall of device 400.

Each of the first through sixth plates 410, 420a, 420b, 430, 440 and 450 includes a first aperture therethrough for defining channel 120 through which flowing gaseous sample 50 may be passed and exposed to photons generated by microplasma 175 disposed in a cavity formed by outer aperture 422, the bottom of first plate 410, and the top of third plate 430. The operation of device 400 is similar to that of device 200, and so will not be repeated.

In device 400, inner wall 424 is cylindrical or substantially cylindrical with a circular cross-section. However, inner wall 424 may have a variety of other shapes and cross-sections, including rectangular, triangular, star-shaped, or any other convenient shape that can efficiently couple photons from microplasma 175 to flowing gaseous sample 50.

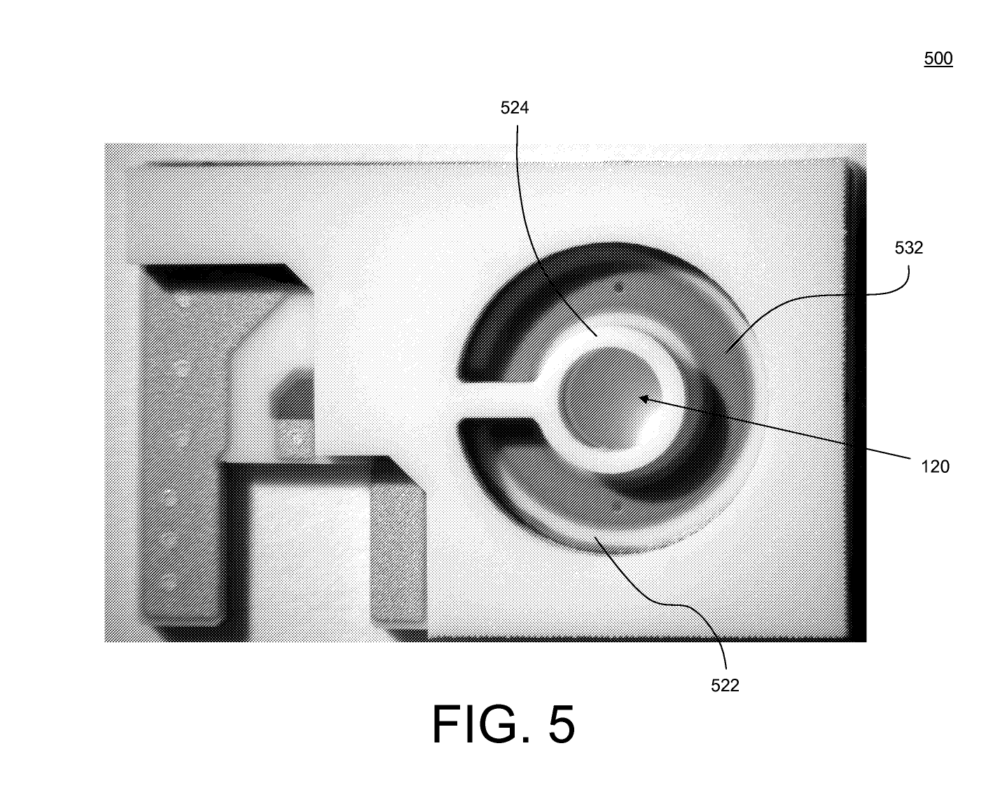

FIG. 5 illustrates one example embodiment of a cavity structure for a microplasma vacuum ultraviolet irradiation device 500. FIG. 5 shows a cavity 532 substantially surrounding channel 120, with a substantially cylindrical inner wall 524 of device 500 separating cavity 532 from channel 120.

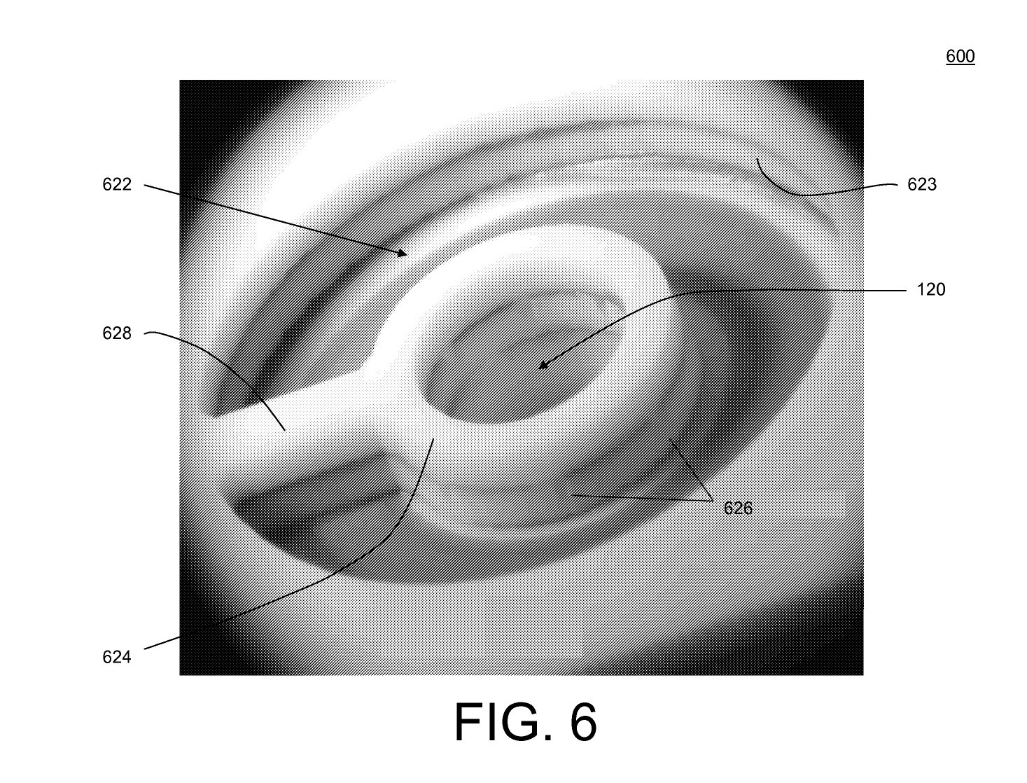

FIG. 6 is a detailed illustration of one example embodiment of a cavity structure 600 for a microplasma vacuum ultraviolet irradiation device. The cavity structure has a cavity 622 defined by an outer wall 623 and an inner wall 624. Inner wall 624 separates cavity 622 from channel 120 through which flowing gaseous sample 50 may be passed. Inner wall 624 has a plurality of orifices 626 passing therethrough from cavity 622 to channel 120, by which flowing gaseous sample 50 may be exposed to photons generated by microplasma 175 disposed in cavity 622. Inner wall 624 is connected to outer wall 623 by radially-extending connecting arm 628.

In one embodiment, inner wall 624 may be cylindrical or substantially cylindrical with a circular cross-section. However, inner wall 624 may have a variety of other shapes and cross-sections, including rectangular, triangular, star-shaped, or any other convenient shape that can efficiently couple photons from microplasma 175 to flowing gaseous sample 50.

One or more embodiments of illumination devices described above may present one or all of the following benefits. high volumetric optical power density, allowing for local production of photons in the vicinity of the gaseous sample; operation at very low gas flow rates, enabling windowless operation inside high-vacuum facilities (thus, not only is the problem of intensity degradation due to window contamination eliminated, but the source is free to emit photons at wavelengths below 120 nm); any of a series of emission wavelengths can be employed (for example, He has an optical resonance at 58.43 nm, emitting photons with energies of 21.22 eV, while Kr has resonances at 116.49 and 123.58 nm, with corresponding photon energies of 10.64 and 10.03 eV); the emission wavelength can be appropriately matched to a desired application; low-energy photons can be used to ionize large molecules with reduced fragmentation; higher-energy photons can be used to intentionally produce molecular fragmentation; and/or photon energies can be chosen to selectively ionize certain compounds without ionizing others. Also, a microplasma system consumes a relatively small amount of power (on the order of 1 W,) is physically compact, and costs much less than alternative means of producing VUV photons.

While example embodiments are disclosed herein, one of ordinary skill in the art appreciates that many variations that are in accordance with the present teachings are possible and remain within the scope of the appended claims. The invention therefore is not to be restricted except within the scope of the appended claims.

1. A device, comprising:
a structure defining a cavity, the cavity substantially encircling a cross-section of a channel passing through the structure, the cavity being defined in part by an interior wall of the structure separating the cavity from the channel, the interior wall including at least one orifice passing therethrough, the structure further including an inlet port connected to the cavity and configured to receive a source gas;
a microplasma disposed within the cavity and generating light that at least in part passes through the at least one orifice in the interior wall;
at least one ignition device for striking the source gas received via the inlet port to generate the microplasma; and
at least one electrode for supplying energy to the microplasma within the cavity.

2. The device of claim 1, wherein the cavity is toroidal and the channel is cylindrical.

3. The device of claim 1, wherein the structure includes a plurality of substrates bonded together, the plurality of substrates including:
a first substrate having the ignition device disposed of a first side thereof and a ground plane on the second side thereof, the first substrate having a first aperture therethrough forming a part of the channel, and a second aperture therethrough for receiving the source gas and supplying the microplasma to the cavity;
a second substrate having an inner aperture therethrough forming a second part of the channel, and a having an outer aperture therethrough substantially surrounding the inner aperture, the second substrate including at least a portion of the inner wall of the structure separating the inner aperture from the outer aperture; and
a third substrate having an aperture therethrough forming a third part of the channel, and having the electrode disposed on a first side thereof.

4. The device of claim 3, wherein the ignition device comprises a split-ring resonator, with the first aperture being disposed between split end portions of the split-ring resonator.

5. The device of claim 3, wherein the inner aperture and outer aperture of the second substrate are substantially coaxial with each other.

6. The device of claim 3, wherein the outer aperture is defined in part by an outer wall in the second substrate, the inner wall being attached to the outer wall by at least one radially-extending arm.

7. The device of claim 1, wherein the structure includes a plurality of substrates bonded together, the plurality of substrates including:
a first substrate having the ignition device disposed of a first side thereof and a ground plane on the second side thereof, the first substrate having a first aperture therethrough forming a part of the channel, and a second aperture therethrough for receiving the source gas and supplying the microplasma to the cavity;
a second substrate having an aperture therethrough;
an insert provided inside the aperture of the second substrate, the insert having an inner aperture extending therethrough forming a second part of the channel, the insert comprising at least a portion of the inner wall of the structure; and
a third substrate having an aperture therethrough forming a third part of the channel, and having the electrode disposed on a first side thereof.

8. The device of claim 1, wherein the light is a vacuum ultraviolet light.

9. The device of claim 1, wherein the channel has an inlet and an outlet, the cavity substantially encircling a cross-section of the channel between the inlet and the outlet, wherein a gaseous sample passes through the channel, and wherein the light is provided to the gaseous sample via the at least one orifice in the internal wall to excite or ionize at least one chemical species in the gaseous sample.

10. The device of claim 9, further comprising a mass spectrometer detector disposed at the outlet of the channel to receive the gaseous sample.

11. A method of exposing a gaseous sample to an excitation light, the method comprising:
providing a structure defining a cavity, the cavity substantially encircling a cross-section of a channel passing through the structure, the cavity being defined in part by an interior wall of the structure separating the cavity from the channel, the interior wall including at least one orifice, the structure further defining an inlet port connected to the cavity;
providing a source gas to the inlet port;
generating a microplasma from the source gas;
providing the microplasma to an interior of the cavity, the microplasma generating light that at least in part passes through the at least one orifice in the interior wall;
supplying energy for sustaining the microplasma within the cavity; and
passing the gaseous sample through the channel so as to expose the gaseous sample to the light generated by the microplasma and to excite or ionize at least one chemical species in the gaseous sample.

12. The method of claim 11, wherein the source gas includes one of a noble gas and hydrogen.

13. The method of claim 11, wherein the source gas includes at least one of krypton and helium.

14. The method of claim 11, wherein the microplasma generates vacuum ultraviolet light.

15. The method of claim 11, wherein striking the source gas includes applying one of an RF and a microwave signal to the source gas to generate the microplasma.

16. The method of claim 15, wherein a resonant structure generates the microplasma from the source gas, and wherein an electrode separate from the resonant structure supplies energy to maintain the microplasma.

17. An illumination device for providing light to a flowing gaseous sample, the device comprising:
a structure including a cavity configured to have a microplasma disposed therein, the cavity substantially encircling a cross-section of a channel that is configured to pass the flowing gaseous sample therethrough, the cavity being defined in part by an interior wall of the structure separating the cavity from the channel, the interior wall including at least one orifice configured to provide to the flowing gaseous sample light generated by the microplasma; and
at least one electrode configured to supply energy to the microplasma within the cavity.

18. The illumination device of claim 17, further comprising an ignition device configured to strike a source gas to generate the microplasma.

19. The device of claim 17, wherein the structure includes a plurality of substrates bonded together, the plurality of substrates including:
a first substrate having an ignition device disposed of a first side thereof and a ground plane on the second side thereof, the first substrate having a first aperture therethrough forming a part of the channel, and a second aperture therethrough configured to receive a source gas and to supply the microplasma to the cavity;
a second substrate having an inner aperture therethrough forming a second part of the channel, and having an outer aperture therethrough substantially surrounding the inner aperture, the second substrate including at least a portion of the inner wall of the structure separating the inner aperture from the outer aperture; and
a third substrate having an aperture therethrough forming a third part of the channel, and having the electrode disposed on a first side thereof.

20. The device of claim 17, wherein the structure includes a plurality of substrates bonded together, the plurality of substrates including:
a first substrate having an ignition device disposed of a first side thereof and a ground plane on the second side thereof, the first substrate having a first aperture therethrough forming a part of the channel, and a second aperture therethrough configured to receive a source gas and to supply the microplasma to the cavity;
a second substrate having an aperture therethrough;
an insert provided inside the aperture of the second substrate, the insert having an inner aperture extending therethrough forming a second part of the channel, the insert comprising at least a portion of the inner wall of the structure; and
a third substrate having an aperture therethrough forming a third part of the channel, and having the electrode disposed on a first side thereof.
